(19) United States
(12) Patent Application Publication
(10) Pub. No.: US 2007/0086153 A1
(43) Pub. Date: Apr. 19, 2007

(54) Display base cable management system and method

(76) Inventors: Randall W. Martin, The Woodlands, TX (US); Paul L. Drew, The Woodlands, TX (US); David Quijano, Magnolia, TX (US); Stephen de Saulles, London (GB); Morten Warren, Surrey (GB); Nick Woodley, London (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/253,187

(22) Filed: Oct. 17, 2005

(51) Int. Cl. G06F 1/16

(52) U.S. Cl. 361/681

(57) ABSTRACT

A cable management apparatus for an electronic system is provided in accordance with certain embodiments of the presently disclosed techniques. Specifically, in one embodiment, the apparatus includes a display base. The display base includes a body having a recessed portion to receive an electronic device and one or more cable routing features disposed within the body. One of the cable routing features is configured to route a cable connected to the electronic device through a portion of the base. A system and a method for managing cables in a display base are also disclosed.

### BACKGROUND

This section is intended to introduce the reader to various aspects of art which may be related to various aspects of the present invention which are described and claimed below. This discussion is believed to be helpful in providing the reader with background information to facilitate a better understanding of the various aspects of the present invention. Accordingly, it should be understood that these statements are to be read in this light, and not as admissions of prior art.

A number of electronic systems, including home entertainment systems, personal computer systems, or the like, include video displays that convey information to a user. Frequently, cables are connected to such displays to provide power to the displays and facilitate communication with other electronic devices. For instance, a computer display generally includes, among other things, a cable for receiving power and another cable for communicating with a computer. As may be appreciated, a system including a display may further include a number of other devices that rely on cables to receive power or communicate with other devices. By way of example, in addition to displays, computer systems typically include input devices, such as keyboards and mice.

Moreover, it may also be desirable to connect a number of other peripheral devices or accessories to the computer system, such as personal digital assistant (PDA) docks, speakers, cameras, digital music players, and so forth. In some instances, such as with portable devices including digital cameras and digital music players, it may be desirable to frequently connect these devices to a computer system to charge batteries of these devices and communicate with the computer system. Such devices may then be disconnected from the computer system, allowing the devices to be used remote from the computer system.

Unfortunately, it can be cumbersome to have a number of cables from various devices and peripherals in the same area. Indeed, the various cables can become tangled and disorganized, resulting in an unaesthetic appearance and logistical issues relating to connecting and disconnecting the cables. For example, devices can become dislodged or disconnected due to cables being snagged or pulled inadvertently. Consequently, there is a need for an apparatus that provides convenient connection options and cable management features in an aesthetically pleasing manner.

### BRIEF DESCRIPTION OF THE DRAWINGS

Advantages of one or more disclosed embodiments may become apparent upon reading the following detailed description and upon reference to the drawings in which:

FIG. 1 is a perspective view of a computer system with various peripheral components disposed about a display and its base, the computer system having cables that pass through a cable routing system on the display base in accordance with certain aspects of the present techniques;

FIG. 2 is a cross-sectional view of multiple flexible lips of the cable routing system, the multiple flexible lips being stacked atop one another to provide layers of cable passages in accordance with one embodiment of the present techniques;

FIG. 3 is a cross-sectional view of the flexible lip adjacent the display base, the flexible lip having a rigid portion and a flexible portion that operates as a biased hinge in accordance with one embodiment of the present techniques;

FIG. 4 is a perspective view illustrating certain features of an exemplary display base including a removable cover in accordance with one embodiment of the present techniques;

FIG. 5 is a perspective view of the display base of FIG. 4 having the cover removed to illustrate additional features of the display base, including a recessed portion adapted to receive an electronic device;

FIG. 6 is a perspective view of the display base of FIG. 5 having an electronic device installed therein to highlight certain cable routing and connection features of the exemplary display base in accordance with certain embodiments of the present techniques;

FIG. 7 is a perspective view of the display base of FIG. 6 having the cover disposed over the recessed portion of the display base to retain cables connected to the electronic device and conceal connections therebetween;

FIG. 8 is a cross-sectional view of an exemplary cable routing feature that includes a flexible lip adjacent the display base, the flexible lip having a U-shaped recess that forms a cable channel for routing the cables in accordance with some embodiments of the present techniques;

FIG. 9 is a cross-sectional view of an alternative cable routing configuration for a flexible lip adjacent the display base, wherein the display base has a U-shaped recess that forms a cable channel for routing the cables in accordance with certain embodiments of the present techniques;

FIG. 10 is a cross-sectional view of the flexible lip adjacent the display base, the display base having an L-shaped recess that forms a cable channel for routing the cables and the flexible lip having a centralized access opening in accordance with other embodiments of the present techniques;

FIG. 11 is a cross-sectional view of the flexible lip adjacent the display base, the flexible lip and display base forming a cavity that operates as a cable passage in accordance with one embodiment of the present techniques;

FIG. 12 is a perspective view of the rear of the display base and the cable routing system, wherein an exit portal cover is being disposed over an exit portal in the cable routing system in accordance with one embodiment of the present techniques; and

FIG. 13 is a perspective view of the rear of the display base and the cable routing system, wherein a connector block is utilized to consolidate cables disposed within the cable routing system in accordance with another embodiment of the present techniques.

### DETAILED DESCRIPTION

One or more specific embodiments of the present technique will be described below. In an effort to provide a concise description of these embodiments, not all features of an actual implementation are described in the specification. It should be appreciated that in the development of any such actual implementation, as in any engineering or design project, numerous implementation-specific decisions will be made to achieve the developers' specific goals, such as compliance with system-related and business-related constraints, which can vary from one implementation to another. Moreover, it should be appreciated that such a development effort can be complex and time consuming, but would remain a routine undertaking of design, fabrication, and manufacture for those of ordinary skill having the benefit of this disclosure. It should be noted that illustrated embodiments of the present technique throughout this text represent a general case.

Embodiments of the present technique generally relate to efficiently and aesthetically managing cables in a workspace while providing convenient device connection options. Specifically, embodiments of the present technique relate to a cable routing system for a display base, which may be defined as a supporting part or a foundation of a display (e.g., the base of a monitor, video screen, all-in-one computer, panel computer, liquid crystal display or television, plasma display or television, or conventional television). Such a routing system facilitates flexible organization, retention, and concealment of cables for peripheral components disposed about or on the display base, such as cables extending from a display situated atop the display base. In one embodiment, the display base includes a recessed portion for receiving and housing an electronic device and a cover that fits over the recessed portion. The cable routing system includes a cable routing feature within the display base for routing a portion of a cable connected to the electronic device. As discussed in detail below, the disclosed routing systems of certain embodiments also include a length of flexible or pliable material (e.g., a pliable flap) disposed along a cable passage or route, such that additional cables can be retained or removed from the cable passage along an edge or through an opening in the pliable material.

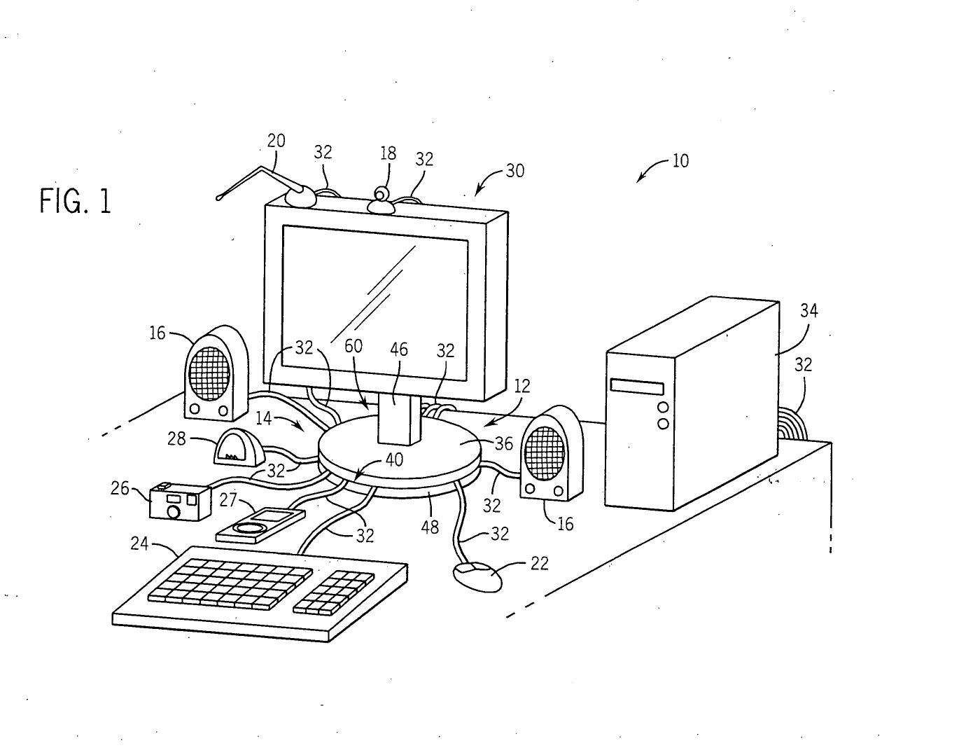

FIG. 1 is a perspective view of a computer system 10 having a cable routing system 12 on a display base 14 in accordance with the present techniques. Specifically, FIG. 1 depicts the computer system 10 with various peripheral devices or components 16, 18, 20, 22, 24, 26, 27, and 28 disposed about the display base 14 and a corresponding display 30. The various peripherals 16, 18, 20, 22, 24, 26, 27, and 28 and the display 30 have cables 32 that pass through the cable routing system 12 on the display base 14. These cables 32 may include power and communication cables. It should be noted that in some embodiments, the cables 32 include those from devices only tangentially related to the computer system 10, such as cables that extend from other devices near the display base 14. For example, the cables 32 can include power cables from an alarm clock, electric pencil sharpener, or electric stapler disposed in or near the workspace surrounding the computer system 10.

The cable routing system 12 flexibly organizes, retains, and conceals all or a portion of the cables 32 from view as they are routed along the display base 14 for various connections, such as to a computer 34, to other peripheral components, or to the display 30. In the illustrated embodiment, the cables 32 from the peripheral components 16, 18, 20, 22, 24, 26, 27, and 28 couple to the display base 14 via the cable routing system 12, some or all of which are accumulated near the rear of the display base 14. This facilitates connection of the cables 32 to the computer 34. However, as provided in greater detail below, cables of some of the peripheral devices may be plugged into an internal communication hub within the display base instead of being routed through the rear of display base 14.

It should be noted that in some embodiments, a number of cables 32 are massed at an exit portal in the cable routing system 12, thus organizing the cables 32 into a group, facilitating efficient use of space, and improving aesthetic appeal. Further, in some embodiments, a connector block is included that communicatively couples to one or multiple of the peripheral components (e.g., 16, 18, 20, 22, 24, 26, 27, 28) or the display 30. Such connector blocks can provide a single point of access via an umbilical cable (e.g., a cable adapted to transmit power, communication signals, or both to and from a number of devices). Additionally, it should be noted that the connector block can be integral or separate from the cable routing system 12.

The cables 32 are routed underneath a strip of flexible material, a pliable flap, or flexible lip 36 of the cable routing system 12. The flexible lip 36 extends outward from a connection point on the display base 14 and forms a cable passage along the periphery of the display base 14. In some embodiments, the cable passage is formed along different portions (e.g., along the middle) of the display base 14. For example, in one embodiment, the flexible lip 36 forms a large cavity over a central portion of the display base 14, thus providing storage and concealment for a large number of cables 32. Indeed, the flexible lip 36 can comprise a flap that covers a majority of the upper surface of the display base 14 and that creates a large cable passage, as illustrated in FIG. 1.

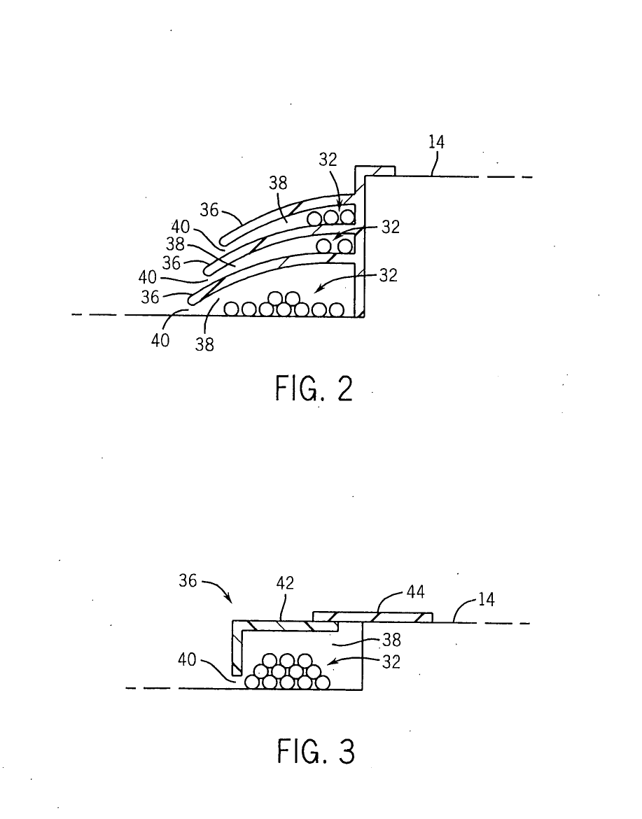

Further, in some embodiments, multiple flexible lips 36 are employed. For example, FIG. 2 is a cross-sectional view that illustrates multiple flexible lips 36 stacked atop one another to provide layers of cable passages 38. Having multiple layers of cable passages 38 enables a user to organize cables 32 according to layer. Moreover, the extra layers provide routing and concealment for additional cables 32.

As illustrated in FIG. 1, the flexible lip 36 extends lengthwise along the periphery of the base, forming a portion of the cable routing system 12. Access to the cable routing system 12 is provided by a slit, groove, or general opening 40 that enables insertion and removal of the cables 32. In one embodiment, the flexible lip 36 includes a single piece or strip of flexible material (e.g., rubber) secured to the display base 14 via an adhesive, screws, latches, or other fasteners.

In another embodiment, as illustrated by FIG. 3, the flexible lip 36 includes a rigid portion 42 and a flexible portion 44 that operates as a biased hinge. The rigid portion 42 lifts up to receive the cables 32 and then the flexible portion 44 causes it to flex back into place, thus retaining the cables 32 in position. The flexible lip 36 is biased against the display base 14 or another flexible lip 36 such that when the cable 32 is routed underneath the flexible lip 36, the cable 32 is retained (e.g., pressed against the display base 14) and at least partially concealed by the flexible lip 36. In one embodiment, the flexible lip 36 is adapted to retain the cable in a chamber separate from the flexible lip 36.

The peripheral components illustrated in FIG. 1 include speakers 16, a camera 18, a microphone 20, a mouse 22, a keyboard 24, a digital camera 26, a digital music player 27, and a personal digital assistant (PDA) linking cradle 28. These are exemplary peripheral components, and it should be noted that different peripheral components can be incorporated in other embodiments. Also, while the display 30 is a flat panel computer monitor in the presently illustrated embodiment, in other embodiments, the display 30 could include a television, a cathode ray tube (CRT), a laptop display, an all-in-one computer, a panel computer, and so forth. For example, the all-in-one computer generally includes the display 30 and computer (e.g., processor, motherboard, memory, and disc drive) all in a single enclosure. By further example, the panel computer includes a flat panel display 30 and a computer disposed in a single panel-shaped housing.

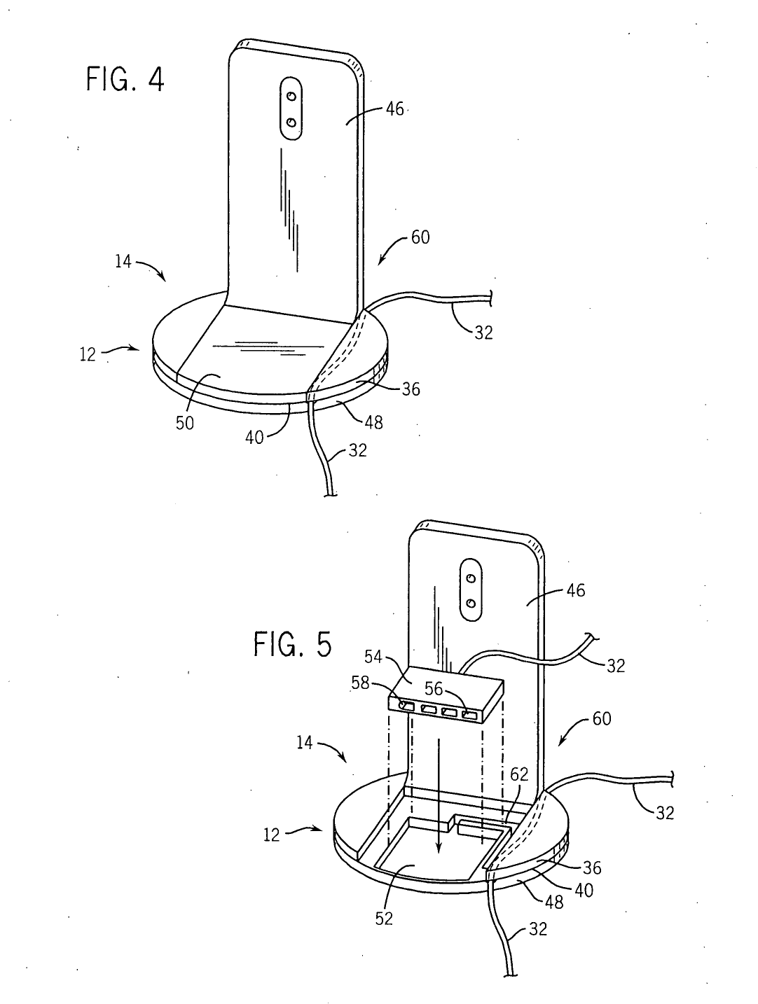

Additional features of an exemplary display base 14 are illustrated in FIG. 4. The display base 14 is coupled to a display stand 46 that facilitates coupling of the display base 14 to the display 30, as illustrated in FIG. 1. In the embodiment illustrated by FIG. 4, a portion of the cable routing system 12 is formed by two adjacent portions of the display base 14: the pliable flap 36 and a footing 48. In the presently illustrated embodiment, the pliable flap 36 is an upper portion of the base and the footing 48 is a lower portion of the base. Other embodiments, however, have different configurations. In some embodiments, the footing 48 is replaced by other suitable adjacent portions. For example, in one alternative embodiment, two adjacent pliable flaps 36 may be used to receive cables 32 therebetween. As will be appreciated, the display base 14 can have various shapes, contours, and other geometric features in full accordance with the present techniques.

Further, while the cable routing system 12 illustrated by FIGS. 1 and 4 is disposed substantially along a perimeter of the display base 14 and has the access opening 40 along the perimeter, in other embodiments, the cable routing system 12 is disposed on different portions of the display base 14. For instance, the cable routing system 12 may comprise a plurality of pliable lips 36 that extend vertically from an upper surface of the display base, a cable passage that extends through a central portion of the display base 14, or some other configuration.

In certain embodiments, the cable routing system 12 is adapted to attach to the display base 14 and to detach therefrom. Particularly, screws, latches, spring-loaded pins, mating connectors, adhesives, tape and so forth can be utilized to couple the cable routing system 12 to the display base 14. Further, in some embodiments, the cable routing system 12 can couple to the upper or lower portion of a standard display base. In other embodiments, the cable routing system can couple to side portions of a standard display base. Providing the cable routing system 12 separate from the display base 14 facilitates transfer of the cable routing system 12 between multiple display bases 14. Further, by facilitating detachment and reattachment of the cable routing system 12 with the display bases 14, a user can dispose cables 32 within the cable routing system 12 prior to connecting the cable routing system to the display base 14. In some embodiments, this improves efficiency and ease of use.

Notably, the display base 14 also includes a cover 50 that is disposed over a recessed portion of the display base 14. The cover 50 may be removed from display base 14 to facilitate insertion of an electronic device within the recessed portion of the display base 14, as illustrated in FIG. 5. Notably, removal of cover 50 exposes a recessed portion or cavity 52 within display base 14. Recessed portion 52 is configured to receive an electronic device or module, such as a communication hub 54. As will be appreciated, other electronic devices can be disposed within display base 14 instead of, or in addition to, communication hub 54 in accordance with the present techniques. For instance, an electronic device or component may include a video module, a sound module, or the like. Further, while a module or device installed within may be directly related to the display in some embodiments, the module or device may be a non-display component (i.e., unrelated to the display) or ancillary to the display in other embodiments.

Communication hub 54 includes a housing, various circuitry disposed within the housing, and a number of connection ports electrically coupled to the internal circuitry to enable electrical communication between a peripheral device connected to communication hub 54 and another device, such as computer 34 (FIG. 1). In certain embodiments, communication hub 54 includes a cable 32 that enables connection to devices external to display base 14, such as computer 34. The connection ports of communication hub 54 may include universal serial bus (USB) ports 56, firewire ports 58, network ports, telephony ports, other similar ports, or combinations thereof. The hub 54 also may include a wireless hub having a plurality of wireless ports. Peripheral devices may be plugged into these connection ports to receive power from, or to communicate with, a device to which communication hub 54 is connected. For instance, input devices, such as mouse 22 and keyboard 24, may be plugged into USB ports 56 of communication hub 54 to transmit inputs to a computer connected to the hub. Similarly, other peripheral devices, such as digital camera 26 or digital music player 27, may be connected to charge internal batteries of such devices and transfer files between the devices and a computer.

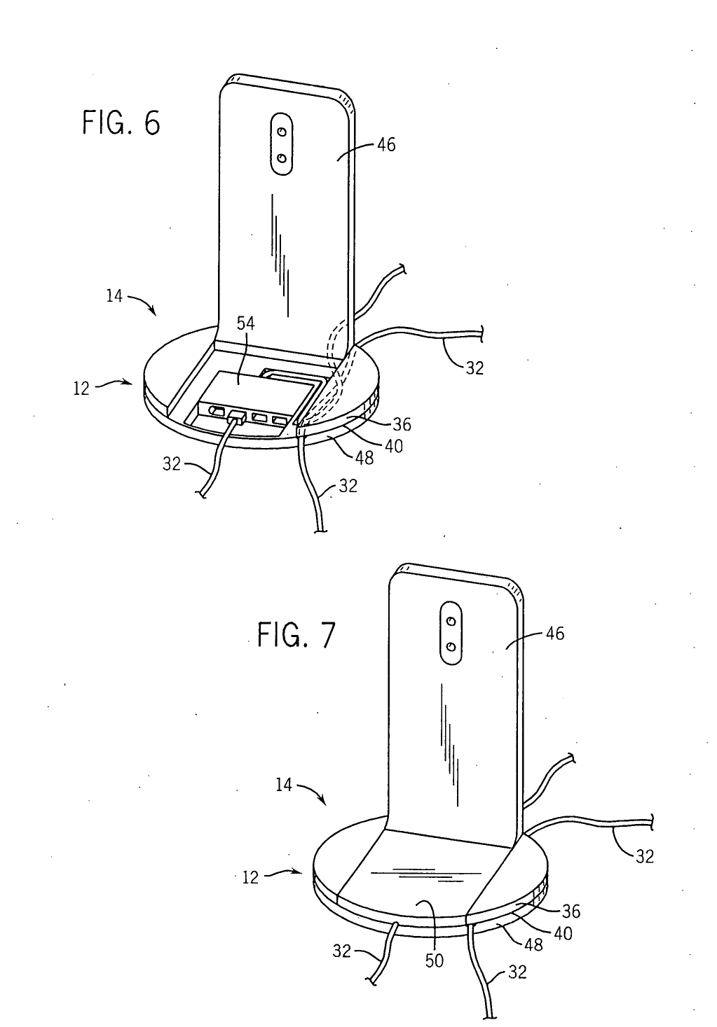

Display base 14 also includes a cable passage 62 that facilitates routing of the communication hub cable 32 through display base 14, as illustrated in FIG. 6. Cover 50 may then be placed over communication hub 54 and cable passage 62 to partially enclose the recessed portion 52 and conceal the connections between the peripheral devices and the communication hub, as well as portions of cables 32 connected to communication hub 54, thus providing a clean aesthetic appearance, as illustrated in FIG. 7. In certain embodiments, cover 52 includes a resilient flexible edge configured to deform about one or more cables 32 extending from communication hub 54, through the front of display base 14, to various peripheral devices. As will be appreciated, this flexible edge may include a strip of rubber, plastic, or the like. This arrangement allows peripheral devices to be installed through the front of display base 14, while providing orderly cable management in an aesthetically appealing manner.

Other configurations are also envisaged in accordance with the present techniques. By way of example, other embodiments of the present techniques may include a cover having a rigid edge that cooperates with a flexible lip of the base to engage cables 32 extending from the display base. Further, other embodiments may include a cover that is configured to provide an opening between the cover and the display base to enable cable routing through the gap. In another embodiment, the cover 50 is coupled to, or is an integral portion of, the electronic device (e.g., hub 54). Moreover, either or both of the cover 50 and the hub 54 may include a variety of fasteners or mounts to connect with the base 14 and, specifically, the recessed portion 52. For example, the fasteners or mounts may include screws, thumb-screws, snap-fit mechanisms, latches, hooks, velcro, or some combination thereof.

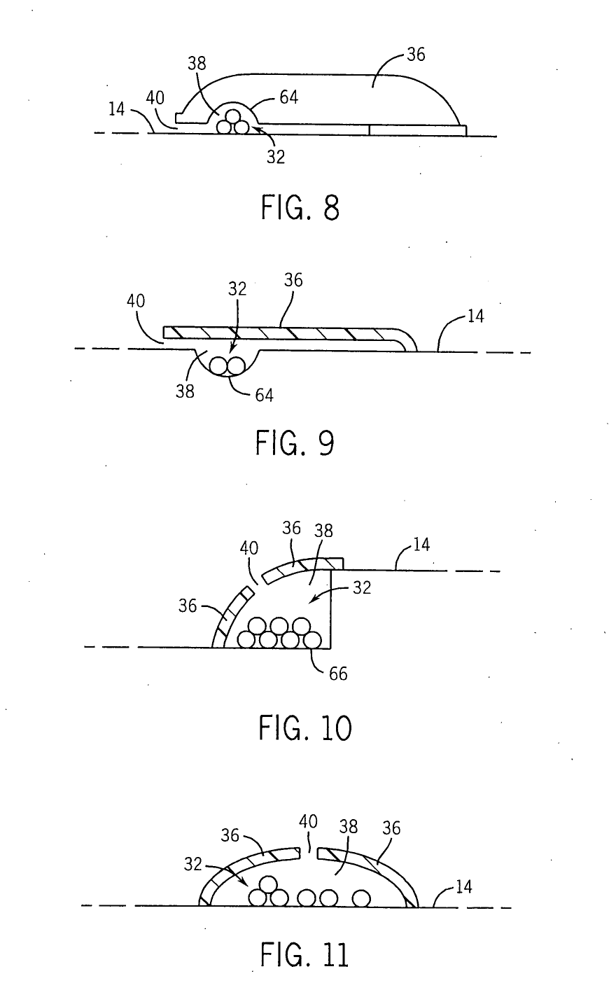

As noted above, cable routing system 12 may include a number of alternative configurations. Several embodiments of the present techniques include a cable passage 38 for receiving and routing cables 32. Notably, the cable passage 38 facilitates retention and concealment of the cables 32 and provides a guide for routing the cables 32. In some embodiments, a cable passage 38 is disposed in the flexible lip 36, in a panel (e.g., the footing 48) adjacent the flexible lip 36, or in both the flexible lip 36 and the panel. For example, in the embodiment illustrated by FIG. 8, the cable passage 38 includes a U-shaped recess 64 in the flexible lip 36. In another embodiment, the cable passage 38 includes a U-shaped recess 64 in a panel of the display base 14 adjacent the flexible lip 36, as illustrated in FIG. 9. In yet another embodiment, the cable passage 38 includes an L-shaped portion 66 of a panel of the display base 14 adjacent the flexible lip 36, as illustrated by FIG. 10. Further, the cable passage 38 can include a cavity or passage between a surface (flat or recessed) of the display base 14 or cable routing system 12 and the flexible lip 36, as illustrated in FIG. 11. It should be noted that FIGS. 10 and 11 also illustrate a central placement of the opening 40 in the flexible lip 36.

In the embodiments illustrated by FIGS. 1 and 4, the cable passage 38 can route a number of cables 32, including cable 32 of communication hub 54, to an exit portal 60 near the back of the display base 14. The exit portal 60 facilitates connection of the communication hub 54 and the various peripheral devices 16, 18, 20, 22, 24, 26, 27, and 28, and so forth to other equipment. Of course, the various peripheral devices may be directly connected to external equipment or connected via communication hub 54. Additionally, the exit portal 60 facilitates arrangement of the cables 32 within the cable routing system 12. In some embodiments, the cable routing system 12 is designed such that the cables 32 can enter the cable routing system 12 at a number of locations along the perimeter of the cable routing system 12 via the opening 40. Once the cables 32 are gathered, some or all of the cables 32 can then uniformly exit the cable routing system 12 at the exit portal 60 for connection to other components (e.g., computer 34).

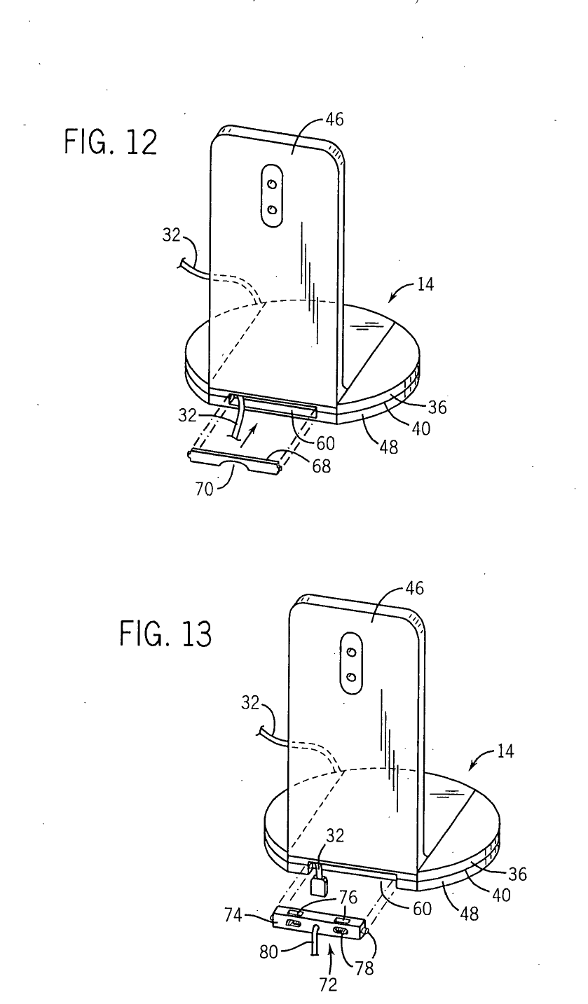

In some embodiments, to improve aesthetic appeal of the display base 14 and to further organize and retain the cables 32, an exit portal cover 68 is provided, as illustrated in FIG. 12. Specifically, FIG. 12 depicts the exit portal cover 68 being disposed over the exit portal 60, to provide additional concealment, support, and securement for the cables 32. When this exit portal cover 68 is removed, ready access is provided to the cables 32 stored in the cable routing system 12. Having this accessibility facilitates insertion, extraction, and manipulation of the cables 32 in the cable routing system 12 via the exit portal 60. When the exit portal cover 68 is in place over and affixed proximate the exit portal 60, the cables 32 are contained and at least partially concealed from view. The exit portal cover 68 includes a slot 70 that provides a discreet (e.g., smaller) access point for the cables 32, thus improving aesthetic appeal, conserving workspace, and improving organization of the cables 32.

FIG. 13 is a perspective view of yet another embodiment of the present technique, wherein a connector block 72 is utilized to consolidate cables 32 and improve organization. Specifically, FIG. 13 depicts the display base 14 having the cable routing system 12 with the exit portal 60 being coupled with the connector block 72 at the exit portal 60. The connector block 72 is adapted or configured to couple to the cable routing system 12 and the cables 32. Specifically, the connector block 72 is adapted or configured to communicatively couple to one or multiple of the cables 32 disposed within the cable routing system 12. Thus, the connector block 72 provides a single point of access to the multiple cables 32 and their corresponding components (e.g., peripheral devices 16, 18, 20, 22, 24, 26, 27, 28 and display 30). In the illustrated embodiment, the connector block 72 comprises a main body 74, a plurality of reception ports 76 for coupling to the various cables 32, a tool-free quick connect and release mechanism 78 for attaching and detaching from the cable routing system 12, and a single umbilical cable 80 that consolidates the attached cables 32. The umbilical cable 80 facilitates communicative connection to a device (e.g., computer 34 or a power source) and transmission of information and power between the device and the cables 32 via the reception ports 76. Additionally, the umbilical cable 80 acts as an extension cord, providing additional length for coupling the cables 32 to other components.

It should be noted that in some embodiments, the tool-free quick connect and release mechanism 78 of the connector block 72 is replaced or supplemented by other connection mechanisms. For example, in some embodiments, latches, screws, male and female components, and so forth can be utilized in place of or in support of the tool-free quick connect and release mechanism 78. Further, it should be noted that while in the illustrated embodiment, the connector block 72 is separate from the cable routing system 12, in other embodiments it is an integral part. In some embodiments, the connector block 72 is integral to the cable routing system 12.

While the present technique may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims.

What is claimed is:

1. A cable management apparatus, comprising:
a base adapted to couple to and support a display, the base comprising:
a body having at least one surface including a recessed portion configured to receive an electronic device; and
at least one cable routing feature disposed in the body and configured to route a first cable coupled to the electronic device through a portion of the base.

2. The cable management apparatus of claim 1, further comprising the electronic device.

3. The cable management apparatus of claim 2, wherein the electronic device comprises a communication hub.

4. The cable management apparatus of claim 3, wherein the communication hub comprises a USB port.

5. The cable management apparatus of claim 3, wherein the communication hub comprises a Firewire port.

6. The cable management apparatus of claim 1, comprising a cover configured to mate with the body to at least partially enclose the recessed portion.

7. The cable management apparatus of claim 6, wherein the cover comprises a flexible edge configured to contact a second cable coupled to the electronic device.

8. The cable management apparatus of claim 1, wherein the at least one cable routing feature is configured to route a second cable through the base.

9. The cable management apparatus of claim 1, wherein the at least one cable routing feature comprises a cable channel.

10. The cable management apparatus of claim 1, wherein the at least one cable routing feature comprises a pliable flap extending at least partially across and lengthwise along a cable route on the base.

11. A system, comprising:
a display base having a recessed portion configured to receive an electronic device, the display base having a first cable routing feature configured to route a first cable coupled to the electronic device through a portion of the display base; and
a display coupled to the display base.

12. The system of claim 11, comprising the electronic device.

13. The system of claim 12, wherein the electronic device comprises a communication hub.

14. The system of claim 13, wherein the electronic device comprises a USB port.

15. The system of claim 11, comprising a cover configured to mate with the display base to at least partially enclose the recessed portion.

16. The system of claim 15, wherein the cover comprises a flexible edge configured to contact a second cable coupled to the electronic device.

17. The system of claim 11, wherein the display base comprises a second cable routing feature configured to route a second cable through the display base.

18. The system of claim 17, wherein the second cable routing feature comprises a pliable flap that extends around at least a substantial portion of a perimeter of the display base.

19. The system of claim 11, wherein the display comprises a flat panel display.

20. The system of claim 11, comprising a computer capable of being communicatively coupled to the display.

21. The system of claim 11, comprising a peripheral device capable of being communicatively coupled to the computer.

22. The system of claim 21, comprising the electronic device, wherein the electronic device is disposed within the recessed portion of the display base and the peripheral device is communicatively coupled to the computer via the electronic device.

23. A method of managing cables, comprising:
receiving a communication hub within a recessed portion of a display base; and
routing a first cable extending from the communication hub through a portion of the display base.

24. The method of claim 23, comprising receiving a cover configured to mate with the display base to at least partially enclose the recessed portion such that a connection port of the communication hub is at least partially concealed.

25. The method of claim 23, comprising:
receiving a second cable between a pliable flap and an adjacent portion of the display base;
routing the second cable along a cable passage between the pliable flap and the adjacent portion; and
retaining the second cable against the adjacent portion via the pliable flap.
